(19) United States
(12) Patent Application Publication
(10) Pub. No.: US 2005/0262184 A1
(43) Pub. Date: Nov. 24, 2005

(54) Method and apparatus for interactively training links in a lockstep fashion

(76) Inventors: Naveen Cherukuri, San Jose, CA (US); Sanjay Dabral, Palo Alto, CA (US); David S. Dunning, Portland, OR (US); Tim Frodsham, Portland, OR (US); Theodore Z. Schoenborn, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/850,856

(22) Filed: May 21, 2004

(51) Int. Cl. G06F 15/16

(52) U.S. Cl. 709/202

(57) ABSTRACT

A method and apparatus for advancing initialization messages in a lock-step manner when initializing an interface is presented. In one embodiment, a lane receiver may transition to a receiver ready attribute when a given number of current training sequence messages is correctly received. When the receiver ready attributes of all the lanes are set, a local acknowledgement attribute may be set. Similarly, a lane receiver may transition to a remote acknowledgement attribute when a given number of current training sequence messages with acknowledgement field set is correctly received. When both the local acknowledgement attribute and the remote acknowledgement attribute are set, the port may advance to the next training sequence messages.

### FIELD

The present disclosure relates generally to data interfaces between agents, and more specifically to point-to-point data interfaces requiring initialization before general operations of data transfer between the agents.

### BACKGROUND

Microprocessor systems have until recently been interconnected via multi-point drop data buses. The processors, memory controllers, input-output controllers (which may generally be termed “agents”) would be able to exchange data over a common data bus structure. However, as data transmission rates become higher, limitations in the multi-point drop data buses are becoming a problem. The electrical loadings and reflections in a multi-point drop data bus system may limit the data transmission speed. In order to address these and other issues, newer systems are examining individual, dedicated point-to-point data interfaces between the agents of a system.

There will still exist variances among agents attempting to exchange data via the point-to-point interfaces. Source impedances, path impedances, and termination impedances may all vary due to process variations and other influences. Data skew among the various parallel data lines, and between the clock and data lines, may become more of a problem at higher data rates. For this reason, during an initialization process the two agents at the opposite ends of the point-to-point interface may exchange special data messages to support the initialization process. For example, pre-determined data messages may help initialize a set of deskewing buffers in a parallel interface. It would be possible to simply send a large number of such messages and presume that the two agents would successfully receive and act upon a sufficient number of them. However this may prove to be a time-consuming process. If the process consumes too much time, it may impact system performance if the initialization is needed not just on a relatively-rare system reset event, but also on commonly occurring events such as transitions between normal operating modes and low-power operating modes.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a schematic diagram of a pair of agents connected via an interface including a pair of point-to-point links, according to one embodiment of the present disclosure.

FIG. 2 is a timing diagram showing advancing from one training sequence to the next, according to one embodiment of the present disclosure.

FIG. 3 is a timing diagram showing receiving of training sequences containing acknowledgements at two receivers, according to one embodiment of the present disclosure.

FIG. 4 is a state diagram showing local and remote acknowledgement states, according to one embodiment of the present disclosure.

FIG. 5 is a schematic diagram showing lane logic and link logic for a local port, according to one embodiment of the present disclosure.

FIG. 6 is a schematic diagram of system including processors supporting an interface including a pair of point-to-point links, according to one embodiment of the present disclosure.

### DETAILED DESCRIPTION

The following description describes techniques for handshaking with acknowledgement to initialize a series of individual data lanes into data links is shown. In the following description, numerous specific details such as logic implementations, software module allocation, signaling techniques, and details of operation are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation. In certain embodiments the invention is disclosed in the form of an interface for connecting together several Itanium® Processor Family (IPF) compatible processors, or for connecting together several Pentium® compatible processors, such as those produced by Intel® Corporation. However, the invention may be practiced for interconnecting other kinds of processors, such as an X-Scale® family compatible processor (but not limited to any family of processor), or for interconnecting other forms of agents, such as memory hubs or input/output device hubs or chipsets. The invention may also be practiced in the interfacing of mixed kinds of processors or other agents. Finally, the invention may be practiced in dedicated point-to-point interfaces, where either the sending and receiving of data occur on a pair of one-directional links, or where the sanding and receiving of data occur on simultaneous bi-directional links.

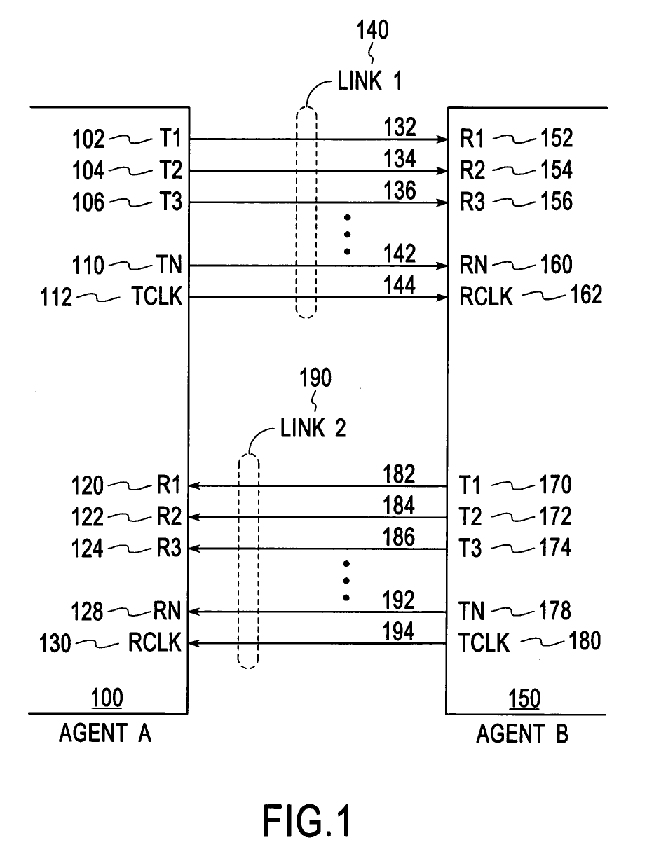

Referring now to FIG. 1, a schematic diagram of a pair of agents connected via an interface including a pair of point-to-point links is shown, according to one embodiment of the present disclosure. For the purpose of the present disclosure, an “agent” may be a processor, digital signal processor, memory controller, input/output controller, chipset, or any other functional circuit that connects to another functional circuit via the interface under consideration. Agent A 100 may be connected to a link 1 140 for transmitting data to agent B 150 and a second link 2 190 for receiving data sent by agent B 150. Link 1 140 and link 2 190 may be said to form an interface between agent A 100 and agent B 150.

Agent A 100 may have series of lane transmitters T1 102 through TN 110 and a clock transmitter TCLK 112 for sending data across link 1 140. In other embodiments, the external clock transmitter may be omitted and the lane transmitters may send self-clocked data. Agent B 150 may have a series of lane receivers R1 152 through RN 160 and a clock receiver RCLK 162 to receive the data and clock sent by agent A 100. Similarly, Agent B 150 may have series of lane transmitters T1 170 through TN 1178 and a clock transmitter TCLK 180 for sending data across link 2 190. In other embodiments, the external clock transmitter may be omitted and the lane transmitters may send self-clocked data. Agent A 100 may have a series of lane receivers R1 120 through RN 128 and a clock receiver RCLK 130 to receive the data and clock sent by agent B 150.

The link 1 140 and link 2 190 are shown as including interconnecting lanes for physical transport between agents A 100 and B 150. The lanes in various embodiments may be unbalanced or balanced, differentially-driven. The number of lanes N may be any number. In some embodiments, when soft errors or hard errors in one or more lane are detected, those lanes may be ignored and the link may be configured for operation as a parallel interface with fewer than N lanes.

The signal path lengths and impedances of lanes 132, 134, 136, up to 142 may have significant differences, which may cause differing signal propagation times. This may cause unacceptable skews between lanes. For this reason, an initialization process may be undertaken upon power-on or other system reset activity. The initialization process may train the individual receivers R1 152 through RN 160 to compensate for skew and other anomalies to permit efficient operation of link 1 140 as a parallel data interface. Similarly the initialization process may train the individual receivers R1 120 through RN 128 to compensate for skew and other anomalies to permit efficient operation of link 2 190 as a parallel data interface.

In one embodiment, a sequence of numbered messages, called “training sequences”, may be sent over the individual lanes (132 through 142) temporarily acting during the initialization process as N individual serial interfaces clocked by TCLK 112. The use of the lanes as individual serial interfaces avoids the skew and other anomalies initially present when using link 1 140 and link 2 190 as parallel interfaces. There may be a first type of training sequence, a second type of training sequence, up to a final type of training sequence. Each of these numbered training sequences may pass parameter data for efficiently setting up the link 1 140. An equivalent series of training sequences may be sent on link 2 190. The outcome of the passing of training sequences back and forth across link 1 140 and link 2 190 may be to configure operational parallel interfaces using the lanes of link 1 140 and link 2 190. For example, the first training sequence may exhibit a known data pattern from which intra-lane skew timing may be determined. A second training sequence may pass parametric data about this timing and also about soft and hard data errors detected in the lanes.

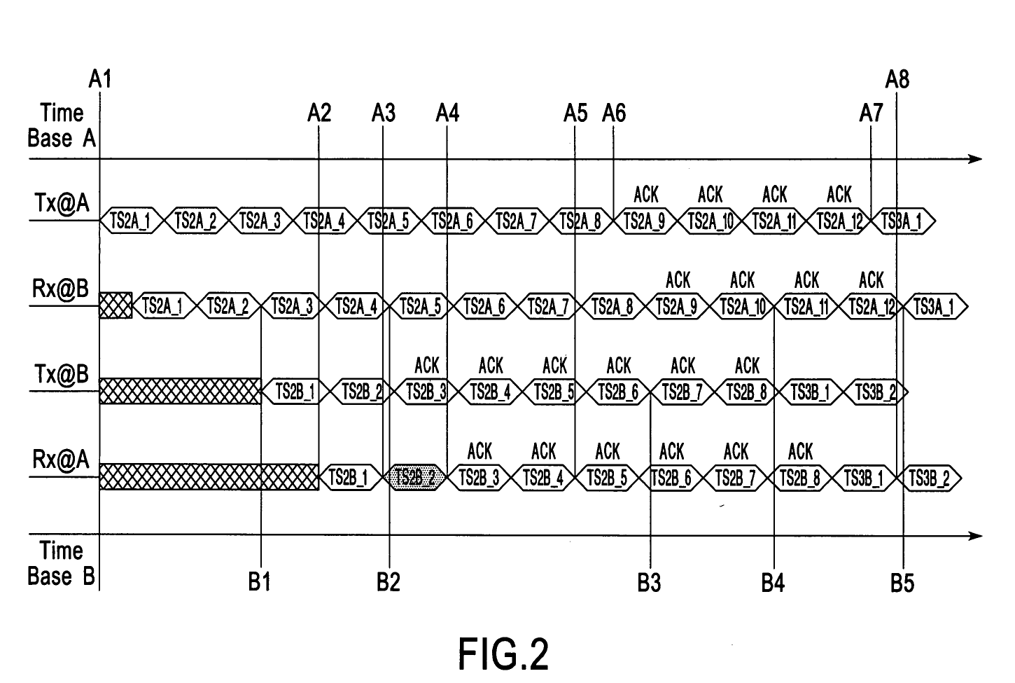

Referring now to FIG. 2, a timing diagram of advancing from one training sequence to the next is shown, according to one embodiment of the present disclosure. It would be possible to send each of the various training sequences for a pre-determined period of time. This would presume that the links would be trained within the collective time period. However, it has been determined that merely using such a timer-based training method would be difficult to validate and also to debug. Therefore, in one embodiment, a fixed time per training sequence has been replaced by a handshaking method that includes acknowledgements.

The FIG. 2 embodiment shows a representative lane from transmitter Tx of agent A sending to receiver Rx of agent B, and corresponding lane in the reverse direction from transmitter Tx of agent B sending to receiver Rx of agent A. Each of the transmitters Tj of agents A and B may send the training sequences in serial form during the initialization process as described above in connection with FIG. 1. Generally what may be received at a given Rx of agent B is what was transmitted at the corresponding Tx of agent A, allowing for a time of flight delay and any errors. FIG. 2 shows events with respect to the two time bases, time base A and time base B, which may be considered with respect to the clocks transmitted by agents A and B, respectively.

FIG. 2 presumes that both agent A and agent B have previously agreed to commence sending the second training sequence message TS2. At time A1, Tx at agent A (Tx @ A) begins transmitting the second training sequence message TS2. It repeats transmitting TS2 as indicated by TS2A_1, TS2A_2, TS2A_3, and so on. These training sequences are received by Rx @ B a short while later. At time B 1, Tx @ B begins its transmission of the second training sequence message TS2.

In one embodiment, each agent agrees to begin sending its training sequences, modified to include an acknowledgement, after it correctly receives from the other agent two consecutive current training sequences. In other embodiments, the number of received current training sequences may be more or fewer than 2, and they need not be received consecutively. The selection of 2 consecutive received training sequences as a criteria may help reduce circuit complexity, as only one training sequence may need to be stored in order to compare with an incoming training sequence. The form of the acknowledgement may be a modification of a data pattern, a flag being set somewhere in the training sequence, or any other means of indicating an acknowledgment.

In keeping with this agreement, both agent A and agent B begin to determine whether they have correctly received two consecutive current training sequences from the other agent as soon as they begin transmitting the current training sequence themselves. At time B 1, agent B begins transmitting at Tx @ B the current training sequence TS2, and examines the receipt of training sequence TS2 at Rx @ B. As agent A has been sending training sequences TS2 from time A1, at time B2 agent B will have successfully received TS2A_3 and TS2A_4. Therefore agent B has successfully received two of the current training sequences, and may then begin adding an acknowledgment indicator to subsequent transmissions of TS2, starting with TS2B_3. In one embodiment, agent B sends at least 4 of the TS2 messages including an acknowledgement. In other embodiments, few than 4 or more than 4 could be sent.

Because agent B began transmitting at a later time B 1, agent A does not begin receiving training sequence TS2 until time A2. The Rx @ A successfully receives TS2B_1, but receives with an error TS2B_2. Only when Rx @ A receives TS2B_3 and TS2B_4, at time A5, does it receive 2 consecutive TS2 messages. Note that these TS2 messages do contain the acknowledgement, but this is permitted. (The second agent to correctly receive the 2 consecutive training sequences may generally be receiving one with an acknowledgement.) Since agent A has received 2 consecutive training sequences at time A5, Tx @ A may then transmit, at time A6, the TS2 messages including an acknowledgement, starting with TS2A_9.

Therefore at time A6 both agent A and agent B are currently transmitting TS2 messages including an acknowledgement. In one embodiment, each agent agrees to begin sending the next in the sequence of training sequences after (1) each agent has begun transmitting the current training sequence including an acknowledgement, and has transmitted at least 4 of these messages and (2) after beginning such transmissions, each agent correctly receives from the other agent two consecutive current training sequences, including an acknowledgement. In other embodiments, the number of received current training sequences including acknowledgement may be more or fewer than 2, and they need not be received consecutively. Additionally, in other embodiments the number of transmitted messages may be more or fewer than 4.

At time B4, agent B has transmitted at least 4 of TS2 including an acknowledgement (TS2B_3 through TS2B_7) and has also subsequently correctly received two consecutive TS2 messages including acknowledgement from agent A (TS2A_9 and TS2A_10). Therefore, agent B may then begin transmitting the next training sequence after TS2, namely TS3, at time B4. The first of these TS3 messages is transmitted from Tx @ B at time B4 (TS3B_1).

Similarly, at time A7, agent A has transmitted at least 4 of TS2 including an acknowledgement (TS2A_9 through TS2A_12) and has also (in this present example) subsequently correctly received two consecutive TS2 messages including acknowledgement from agent B (TS2B_6 and TS2A_7). Therefore, agent A may then begin transmitting the next training sequence after TS2, namely TS3, at time A7. The first of these TS3 messages is transmitted from Tx @ A at time A7 (TS3A_1). (It is noteworthy that the transmission of at least 4 of TS2 including an acknowledgement and correctly receiving two consecutive TS2 messages including acknowledgement from agent B may in fact occur in any order.)

The FIG. 2 example showed handshaking with acknowledgment for a representative pair of lanes Tx @ A−Rx @ B and Tx @ B−Rx @ A between agent A and agent B. It is intended that the transmissions of training sequences may take place across all of the lanes. In this case, if there is an error in reception on one lane (e.g. TS2B_2), then that lane may disregard the corresponding training sequence for the purpose of changing from transmitting a training sequence to transmitting the training sequence with acknowledgement, or for the purpose of changing from transmitting one training sequence to transmitting a subsequent training sequence. In some embodiments, the lanes encountering many soft errors, or a hard error, may be removed from the handshaking process.

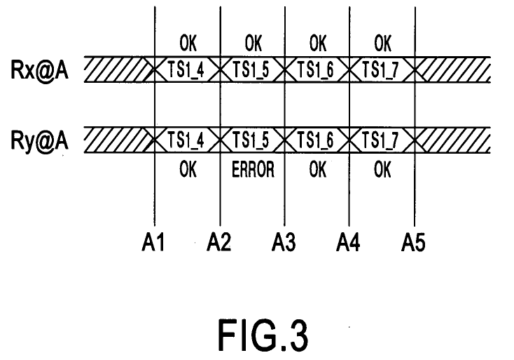

Referring now to FIG. 3, a timing diagram of receiving of training sequences containing acknowledgements at two receivers is shown, according to one embodiment of the present disclosure. Here the two receivers are Rx @ A and Ry @ A of agent A. At time A1, agent A begins looking for 2 consecutive training sequences with acknowledgement. Rx @ A and Rx @ B both successfully receive TS1_4. But then Rx @ A successfully receives TS1_5, while Ry @ A receives TS1_5 with an error. Although at time A3 Rx @ A has received 2 consecutive training sequences with acknowledgement, Ry @ A has not. Therefore agent A does not proceed to transmitting TS2 messages, but waits until Ry @ A has received 2 consecutive training sequences with acknowledgement. Only at time A5, after Ry @ A has successfully received TS1_6 and TS1_7, may agent A proceed to transmitting TS2 messages. In other embodiments, the number of training sequences to receive may be fewer than or greater than 2.

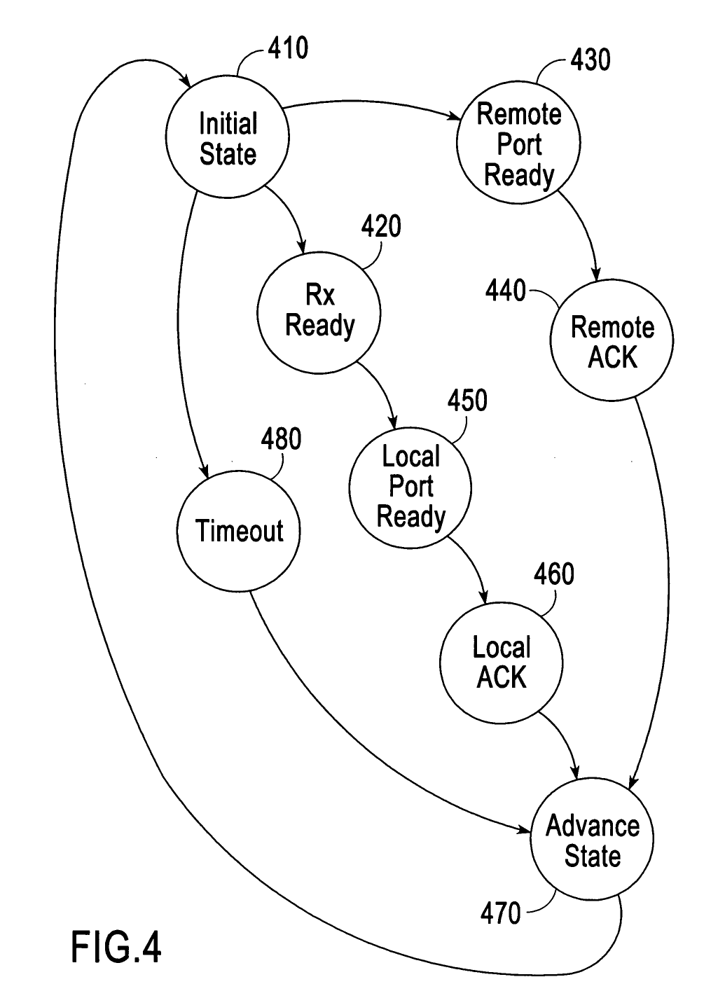

Referring now to FIG. 4, a state diagram of local and remote acknowledgement states is shown, according to one embodiment of the present disclosure. The previous FIGS. 1 through 3 emphasized the symmetric nature of the interface. In the FIG. 4 embodiment, the behavior of the agent at the near-side of the interface will be discussed. For this reason the agent at the near-side of the interface will be called a local port, and the corresponding agent at the far-side of the interface will be called a remote port, even though both ports may be equivalent or at least interoperable. The states shown in FIG. 4 may be referred to by their attributes, which may be indicated by a software flag, a hardware signal, or any other means to indicate the respective attribute.

The local port may have N receivers and transmitters, which may be numbered R1 through RN, and T1 through TN, respectively. A representative receiver and transmitter may be called Rx and Tx, respectively. When the local port has entered an initial state 410, it may be transmitting and expecting to receive training sequences TSn without the acknowledgement fields being set. The receivers Rx of each lane may examine each received message to determine whether they contain the proper TSn header and whether the TSn is correctly received.

When a local receiver Rx receives and correctly interprets at least two consecutive TSn messages, the local receiver Rx may then transition to an Rx Ready 420 attribute. In other embodiments, the number of TSn messages to be received and correctly interpreted may be different than two, and they may not necessarily be consecutive. It is noteworthy that there may be an Rx Ready 420 attribute set for each of the Rx receivers, R1 through RN, and that the Rx Ready 420 attributes on the various Rx may be set at differing times. The Rx may ignore a training sequence with a header that does not match the expected TSn header of the current training sequence. Any such unexpected training sequence header will not cause the Rx to reset its Rx Ready 420 attribute. Once the Rx Ready 420 attribute is set for a given Rx, it will not be reset until the current TSn training state advances to the next TS(n+1) training state. This may be true even when subsequent incoming TSn may have their acknowledgement fields cleared.

When all of the Rx have their Rx Ready 420 attribute set, then the local port may then transition to a Local Port Ready 450 attribute. The Local Port Ready 450 attribute is an attribute of the entire receiver section of the local port. Once all the processing of the received TSn messages are complete, then the Local Port Ready 450 attribute may transition to Local Acknowledgement (Local ACK) 460 attribute. The Local ACK 460 attribute is an attribute of the entire local port. When Local ACK 460 attribute is set, the local Tx may insert an acknowledgement field into the current training sequence messages TSn. Once the local port has acquired the Local ACK 460 attribute, the local Tx may continue to send the TSn with the acknowledgement field set for the remainder of the TSn training state. The Local ACK 460 attribute being set may indicate that the local port is currently ready to advance to the next training state.

In the cases where errors persist in one or more of the Rx, some of the Rx may not have their Rx Ready 420 attribute set for an inordinate amount of time. Therefore, a timeout period may be set in the Initial State 410, and any Rx for which the Rx Ready 420 attribute is not acquired during the timeout period may initiate a transition to a Timeout 480 attribute. When the Timeout 480 attribute is set for a given Rx, the lanes corresponding to Rx for which Rx Ready 420 attribute is not acquired may be masked out from further consideration in the initialization process. Any Timeout 480 attribute being set transitions directly to the Advance State 470 attribute.

When any local receiver Rx receives and correctly interprets at least two consecutive TSn messages with an acknowledgement field set, the local receiver Rx may then transition to an Remote Port Ready 430 attribute. In other embodiments, the number of TSn messages with acknowledgement to be received and correctly interpreted may be different than two, and they may not necessarily be consecutive. When at least one local receiver Rx has the Remote Port Ready 430 attribute set, then the local port may transition to a Remote ACK 440 attribute. It is noteworthy that only one local receiver Rx receiving the required TSn messages with acknowledgement may initiate the transition to the Remote ACK 440 attribute. The Remote ACK 440 attribute being set may indicate that the remote port is currently ready to advance to the next training state.

When both the Local ACK 460 attribute and the Remote ACK 440 attribute are set, they may transition to the Advance State 470 attribute. In one embodiment, when both the Local ACK 460 attribute and the Remote ACK 440 attribute are set, and at least four TSn messages with the acknowledgement fields set have been transmitted by the local port, the local port may transition to the Advance State 470. In other embodiments, differing numbers of TSn messages with the acknowledgement fields set may be transmitted. Then the Advance State 470 attribute may transition to the Initial State 410 attribute and begin sending the TS(n+1) training sequences. It is noteworthy that there is no timing dependency between setting Remote ACK 440, and sending the four TSn messages with the acknowledgement fields set. Either of these may occur in either order.

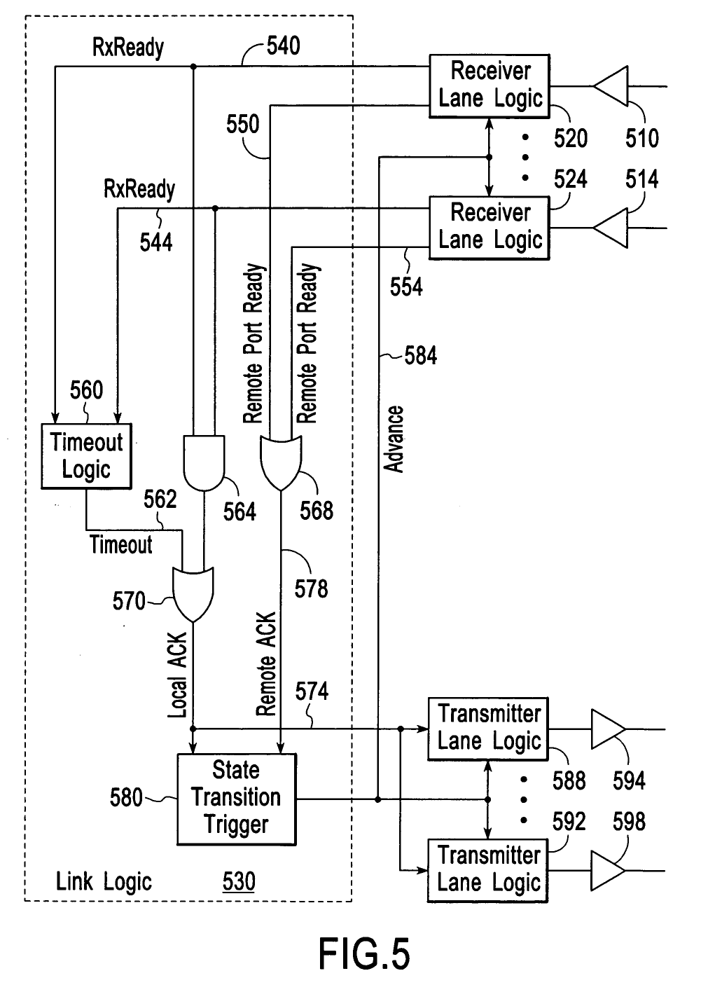

Referring now to FIG. 5, a schematic diagram of lane logic and link logic for a local port is shown, according to one embodiment of the present disclosure. The link logic 530 generally controls operations for the entire port, and in one embodiment may include Timeout Logic 560, AND gate 564, OR gate 568, OR gate 570, and State Transition Trigger 580. In other embodiments, link logic 430 may have other elements. Lane logic may include lane receivers R1 510 through Rn 514, receiver lane logics 520 through 524, transmitter lane logics 588 through 592, and lane transmitters 594 through 598.

Data received by a series of lane receivers R1 510 through Rn 514 are sent to a series of receiver lane logics 520 through 524. For clarity, only two lane receivers and two receiver lane logics are shown. In one embodiment, the receiver lane logics 530 through 524 may be finite state machines. In other embodiments, the receiver lane logics 520 through 524 may include processors operating under software or firmware, or may be other forms of logic.

When any receiver lane logic 520 through 524 receives and correctly interprets at least two consecutive TSn messages, the receiver lane logic may then issue a RxReady signal. For example, receiver lane logic 520 would issue RxReady signal 540. In other embodiments, the number of TSn messages to be received and correctly interpreted may be different than two, and they may not necessarily be consecutive. For the sake of clarity, only two RxReady signals 540, 544 are shown but there would generally be an RxReady signal per lane receiver. It is noteworthy that that the RxReady signals for the various lane receivers may be set at differing times. The receiver lane logic may ignore a training sequence with a header that does not match the expected TSn header of the current training sequence. Any such unexpected training sequence header will not cause the receiver lane logic to reset its RxReady signal. Once the RxReady signal is set for a given receiver lane logic, it will not be reset until the current TSn training state advances to the next TS(n+1) training state. This may be true even when subsequent incoming TSn may have their acknowledgement fields cleared.

The RxReady signals 540 through 544 may be logically added together by a multi-input AND gate 564, or similar logic, to form a Local ACK signal 574. The RxReady signals 540 through 544 may also be routed to a Timeout Logic 560. In one embodiment, if any RxReady signals have not been issued by the time a chosen period of time has elapsed, then the Timeout Logic 560 may issue a Timeout signal 562. In this embodiment, the Timeout signal 562 may be logically OR'ed with the output of AND gate 564 to produce the Local ACK signal 574.

The Local ACK signal 574 may be routed to a series of transmitter lane logics 588 through 592. In one embodiment, when each transmitter lane logic receives the Local ACK signal 574, it begins transmitting the current training sequences with the acknowledgement field set. For clarity, only two lane transmitters and two transmitter lane logics are shown. In one embodiment, the transmitter lane logics 588 through 592 may be finite state machines. In other embodiments, the transmitter lane logics 588 through 592 may include processors operating under software or firmware, or may be other forms of logic.

When any receiver lane logic 520 through 524 receives and correctly interprets at least two consecutive TSn messages with the acknowledgement field set, the receiver lane logic may then issue a RemotePortReady signal. For example, receiver lane logic 520 would issue RemotePortReady signal 550. In other embodiments, the number of TSn messages with the acknowledgement field set to be received and correctly interpreted may be different than two, and they may not necessarily be consecutive. For the sake of clarity, only two RemotePortReady signals 550, 554 are shown but there would generally be a RemotePortReady signal per lane receiver. The RemotePortReady signals 540 through 544 may be logically or'ed together by a multi-input OR gate 568, or similar logic, to form a Remote ACK signal 578.

Local ACK signal 574 and Remote ACK signal 578 may be routed to a State Transition Trigger 580. In one embodiment, State Transition Trigger 580 may issue an Advance signal 584 when both Local ACK signal 574 and Remote ACK signal 578 have been issued, and when in addition at least four training sequences with acknowledgement fields set have been transmitted. The Advance signal 584 may be routed to all the receiver lane logics 520 through 524 and all the transmitter lane logics 588 through 592. The receiver lane logics 520 through 524 may interpret the Advance signal 584 as permission to switch from receiving and examining the current training sequence messages TSn to receiving and examining the next training sequence messages TS(n+1). The transmitter lane logics 588 through 592 may interpret the Advance signal 584 as permission to switch from transmitting the current training sequence messages TSn to transmitting the next training sequence messages TS(n+1).

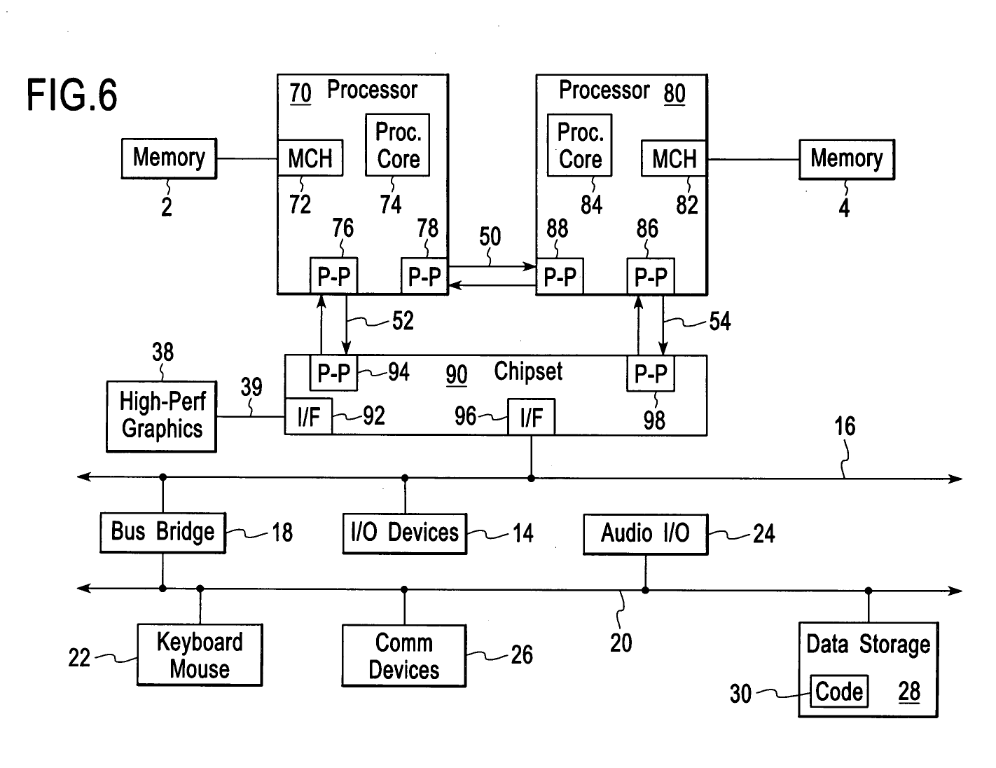

Referring now to FIG. 6, a schematic diagram of system including a processors supporting an interface including a pair of point-to-point links is shown, according to one embodiment of the present disclosure. The FIG. 6 system generally shows a system where processors, memory, and input/output devices are interconnected by a number of point-to-point interfaces.

The FIG. 6 system may include several processors, of which only two, processors 70, 80 are shown for clarity. Processors 70, 80 may each include a local memory controller hub (MCH) 72, 82 to connect with memory 2, 4. Processors 70, 80 may exchange data via a point-to-point interface 50 using point-to-point interface circuits 78, 88. Processors 70, 80 may each exchange data with a chipset 90 via individual point-to-point interfaces 52, 54 using point to point interface circuits 76, 94, 86, 98. In one embodiment, point-to-point interfaces 50, 52, 54 may be interfaces as described in FIGS. 1 through 5 of the present disclosure. Chipset 90 may also exchange data with a high-performance graphics circuit 38 via a high-performance graphics interface 92.

In the FIG. 6 system, chipset 90 may exchange data with a bus 16 via a bus interface 96. In the system, there may be various input/output I/O devices 14 on the bus 16, including in some embodiments low performance graphics controllers, video controllers, and networking controllers. Another bus bridge 18 may in some embodiments be used to permit data exchanges between bus 16 and bus 20. Bus 20 may in some embodiments be a small computer system interface (SCSI) bus, an integrated drive electronics (IDE) bus, or a universal serial bus (USB) bus. Additional I/O devices may be connected with bus 20. These may include keyboard and cursor control devices 22, including mice, audio I/O 24, communications devices 26, including modems and network interfaces, and data storage devices 28. Software code 30 may be stored on data storage device 28. In some embodiments, data storage device 28 may be a fixed magnetic disk, a floppy disk drive, an optical disk drive, a magneto-optical disk drive, a magnetic tape, or non-volatile memory including flash memory.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. A method, comprising:
determining a local acknowledgement attribute from received first training sequences;
determining a remote acknowledgement attribute from said received first training sequences; and
advancing to second training sequences based upon said local acknowledgement attribute and said remote acknowledgement attribute.

2. The method of claim 1, wherein said determining said local acknowledgement attribute includes determining a local port ready attribute.

3. The method of claim 2, wherein said determining said local port ready attribute includes determining a first receiver ready attribute and a second receiver ready attribute.

4. The method of claim 3, wherein said determining said first receiver ready attribute includes determining receipt of a first number of said first training sequences.

5. The method of claim 1, wherein said determining a remote acknowledgement attribute includes determining a remote port ready attribute.

6. The method of claim 5, wherein said determining said remote port ready attribute includes determining receipt of a second number of said first training sequences with acknowledgment.

7. An apparatus, comprising:
a first receiver lane logic to make a first receiver ready signal from a received first training sequence;
a link logic to make a local acknowledgement signal from said first receiver ready signal; and
a transmitter lane logic responsive to said local acknowledgement signal to enable transmission of said first training sequences with acknowledgement.

8. The apparatus of claim 7, wherein said first receiver lane logic makes said receiver ready signal responsive to receiving a first number of said first training sequence.

9. The apparatus of claim 7, wherein said receiver lane logic to make a first remote port ready signal responsive to receiving a second number of said first training sequence with acknowledgement.

10. The apparatus of claim 9, wherein said link logic to make a remote acknowledgement signal from said first remote port ready signal or from a second remote port ready signal.

11. The apparatus of claim 10, wherein said link logic to make said local acknowledgement signal from summing said first receiver ready signal and a second receiver ready signal.

12. The apparatus of claim 10, wherein said link logic to make an advance signal from said remote acknowledgement signal and said local acknowledgement signal.

13. The apparatus of claim 12, wherein said first receiver lane logic to make said first receiver ready signal from a received second training sequence subsequent to receiving said advance signal.

14. The apparatus of claim 12, wherein said transmitter lane logic to initiate sending a second training sequence subsequent to receiving said advance signal.

15. An apparatus, comprising:
means for determining a local acknowledgement attribute from received first training sequences;
means for determining a remote acknowledgement attribute from said received first training sequences; and
means for advancing to second training sequences based upon said local acknowledgement attribute and said remote acknowledgement attribute.

16. The apparatus of claim 15, wherein said means for determining said local acknowledgement attribute includes means for determining a local port ready attribute.

17. The apparatus of claim 16, wherein said means for determining said local port ready attribute includes means for determining a first receiver ready attribute and a second receiver ready attribute.

18. The apparatus of claim 17, wherein said means for determining said first receiver ready attribute includes means for determining receipt of a first number of said first training sequences.

19. The apparatus of claim 15, wherein said means for determining a remote acknowledgement attribute includes means for determining a remote port ready attribute.

20. The apparatus of claim 19, wherein said means for determining said remote port ready attribute includes means for determining receipt of a second number of said first training sequences with acknowledgment.

21. A system, comprising:
a local port including a first receiver lane logic to make a first receiver ready signal from a received first training sequence, a link logic to make a local acknowledgement signal from said first receiver ready signal, and a transmitter lane logic responsive to said local acknowledgement signal to enable transmission of said first training sequences with acknowledgement; and
a remote port to transmit said received first training sequence to said local port.

22. The system of claim 21, wherein said first receiver lane logic makes said receiver ready signal responsive to receiving a first number of said first training sequence.

23. The system of claim 21, wherein said receiver lane logic to make a first remote port ready signal responsive to receiving a second number of said first training sequence with acknowledgement sent by said remote port.

24. The system of claim 23, wherein said link logic to make a remote acknowledgement signal from said first remote port ready signal or from a second remote port ready signal.

25. The system of claim 24, wherein said link logic to make said local acknowledgement signal from summing said first receiver ready signal and a second receiver ready signal.

26. The system of claim 24, wherein said link logic to make an advance signal from said remote acknowledgement signal and said local acknowledgement signal.

27. The system of claim 26, wherein said first receiver lane logic to make said first receiver ready signal from a received second training sequence transmitted by said remote port subsequent to receiving said advance signal.

28. The system of claim 26, wherein said transmitter lane logic to initiate transmitting a second training sequence to said remote port subsequent to receiving said advance signal.

29. A computer readable media, containing a program which when executed by a machine performs the process comprising:
determining a local acknowledgement attribute from received first training sequences;
determining a remote acknowledgement attribute from said received first training sequences; and
advancing to second training sequences based upon said local acknowledgement attribute and said remote acknowledgement attribute.

30. The computer readable media of claim 29, wherein said determining said local acknowledgement attribute includes determining a local port ready attribute.

31. The computer readable media of claim 30, wherein said determining said local port ready attribute includes determining a first receiver ready attribute and a second receiver ready attribute.

32. The computer readable media of claim 31, wherein said determining said first receiver ready attribute includes determining receipt of a first number of said first training sequences.

33. The computer readable media of claim 29, wherein said determining a remote acknowledgement attribute includes determining a remote port ready attribute.

34. The computer readable media of claim 33, wherein said determining said remote port ready attribute includes determining receipt of a second number of said first training sequences with acknowledgment.
